(19) United States
(12) Patent Application Publication
(10) Pub. No.: US 2008/0200576 A1
(43) Pub. Date: Aug. 21, 2008

(54) Polymeric Nanocomposite Materials Obtained by Controlled Nucleation Of Dendritic Polymers

(75) Inventors: Matthias Seiler, Griesheim (DE); Pedro Cavaleiro, Viersen (DE); Kathrin Lehmann, Leverkusen (DE); Bernd Weyershausen, Essen (DE); Markus Schwarz, Haltern am See (DE); Friedrich Georg Schmidt, Haltern am See (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/720,286

(22) PCT Filed: Nov. 25, 2005
(86) PCT No.: PCT/EP2005/056213

§ 371 Date: Apr. 23, 2008

(30) Foreign Application Priority Data
Nov. 27, 2004 (DE) 10 2004 057 430.8

(51) Int. Cl. C08G 63/00; C08F 2/00; C08G 71/04; C08K 5/3417; C08K 3/22; C08F 2/01

(52) U.S. Cl. 522/3; 522/153; 522/155; 522/160; 522/161; 522/162; 522/164; 522/165; 522/75; 522/78; 522/83

(57) ABSTRACT

The invention provides a process for producing a polymer mixture, which process is characterized in that nanoscale agglomerates of dendritic polymers having a molar mass of between 400 and 100 000 g/mol are formed by lowering the temperature to below the upper critical solution temperature or raising the temperature to above the lower critical solution temperature of the system in a polymer matrix, and the system is converted into the solid aggregate state by polymerization, temperature change, UV curing, pressure lowering, heat treatment or evaporation of volatile components of the system.

The invention relates to a process for producing polymeric nanocomposite materials for coatings, packaging or containers, having improved permeability properties and mechanical properties, formed by controlled nucleation of dendritic polymers in the polymer matrix.

For numerous plastics-based types of packaging, containers or coatings a minimal gas and liquid permeability in tandem with good mechanical properties is essential. There are various ways of producing a barrier action with respect to the permeation of gases or liquids in a polymeric packaging or coating material.

One way is to apply a barrier layer to the surface. This method has the grave disadvantage of susceptibility to mechanical or chemical damage. Increasingly, therefore, the switch is being made to mixing the polymer matrix (base polymer) with components that generate a barrier action (barrier components).

On account of their advantageous ratio of volume to surface area, mineral compounds with layer structures are used as barrier components, especially silicates such as hectorite and montmorillonites (clay).

On the one hand, the hydrophilic clays are compatible inadequately, if at all, with the predominantly apolar base polymers; on the other, the cohesive energy between the individual layers is sufficiently great to make direct comminution of the particles, and their dispersion in base polymers, impossible.

To improve the compatibility with the base polymers and to facilitate the comminution and distribution in polymers, therefore, they have to be organically modified.

According to the disclosure in WO-A-00/78855 it is possible, for modifying the clays, to make use in particular of onium salts such as ammonium salts or phosphonium salts, or else, in accordance with WO-A-93/04118, the hydrophilic smectic clay is converted by silane adsorption into an “organophilic” clay.

In lieu of the onium salts, WO-A-03/016392 proposes using dendrimers or hyperbranched polymers to modify the layered silicates (phyllosilicates). These polymers are intended to expand the interlayer distance much more and hence to make it very much easier to comminute the particles and to distribute them in the base polymers.

The effectiveness of the barrier action with respect to gas and liquid permeation in barrier blends or nanocomposites, the quality of the mechanical properties, the scratch resistance, the gloss and the abrasion resistance, the chemical resistance, and the easy-to-clean properties of systems composed of a base polymer and a polymeric barrier component (these systems being referred to below as barrier blends), and also of nanocomposites, depend substantially on the homogeneity of distribution and on the volume content of the barrier components and/or nanoparticles (discontinuous phase). They become better in proportion with the uniformity of distribution of a solid discontinuous phase in the base polymer and with an increasing volume fraction of said phase.

The prior-art barrier components require costly and inconvenient pretreatment. In spite of this, the stable, homogeneous distribution of barrier components or nanoparticles is realizable only at relatively low concentrations, a concentration range which permits only a low barrier action with respect to gas and liquid permeation. Although the barrier action can be increased further by raising the concentration of the barrier components, the mechanical moduli of the barrier blend become poorer, owing to an increasingly less homogeneous distribution of the discontinuous phase.

Furthermore, the transparency which is desirable for many types of packaging is no longer realizable for the majority of conventional barrier components or nanoparticles within a concentration range that allows a sufficient barrier action with respect to gas and liquid permeation; and, moreover, many conventional barrier blends lose their oxygen barrier action on contact with water, which is why use is often made of complex, multilayer barrier systems with a sandwich construction.

A further disadvantage of the prior art is that coatings with a low gas or liquid permeability frequently exhibit inadequate scratch resistance, abrasion resistance, wettability or chemical resistance, or a poor pigment-binding capacity, at the same time as an excessive melt viscosity and a friction coefficient which is too high.

There was therefore a need for barrier components and nanoparticles which eliminate these disadvantages of the prior art i.e., which, without costly and inconvenient pretreatment, and even at high concentrations, are stable with the base polymer, are homogeneously miscible, and in some cases are also transparent, and also are able to improve scratch resistance, pigment-binding capacity or viscosity-related processing properties.

This object is achieved through controlled nucleation of dendritic polymers in the polymer matrix. The dendritic polymers encompass not only the polydisperse hyperbranched polymers but also the monodisperse dendrimers.

The invention provides a process for producing polymer mixtures, characterized in that nanoscale agglomerates of dendritic polymers having a molar mass of between 400 and 100 000 g/mol are formed by lowering the temperature to below the upper critical solution temperature or raising the temperature to above the lower critical solution temperature of the system in a polymer matrix, and the system is converted into the solid aggregate state by polymerization, temperature change, UV curing, pressure lowering, heat treatment or evaporation of volatile components of the system.

The invention further provides a process characterized in that the nanoscale polymer agglomerates are composed of one or more dendritic polymers having a glass transition temperature above 10° C. and having a concentration in the polymer mixture of not more than 50% by mass, preferably not more than 40% by mass, and more preferably not more than 30% by mass.

References to hyperbranched and highly branched polymers are to a class of innovative materials characterized by an optionally irregularly shaped globular molecule structure and by a large number of functional groups in the molecule. The highly branched molecular architecture results in a particular combination of properties, such as low melt viscosity and/or solution viscosity, and excellent solubility in numerous solvents.

The technical literature also refers to the highly branched, globular polymers as “dendritic polymers”. These dendritic polymers can be subdivided into two different categories: the “dendrimers” and the “hyperbranched polymers”. Dendrimers are three-dimensional, monodisperse polymers possessing ultrahigh regularity and a treelike, globular structure. This structure is characterized by three distinct regions: A polyfunctional central core, representing the center of symmetry; various well-defined, radially symmetric layers of a repeating unit; and the end groups. In contrast to the dendrimers, the hyperbranched polymers are polydisperse and irregular in terms of their branching and structure. One example each of a dendrimer and of a highly branched polymer, constructed from repeating units each of which has three bonding possibilities, is shown in the structures below:

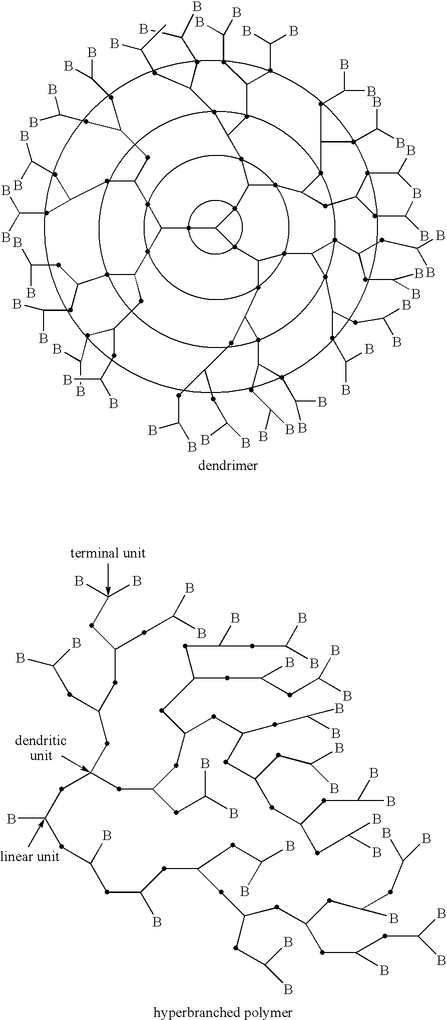

Concerning the different possibilities for the synthesis of dendrimers and hyperbranched polymers, reference may be made to Fréchet J. M. J., Tomalia D. A., Dendrimers and Other Dendritic Polymers, John Wiley & Sons, Ltd., West Sussex, UTK 2001 and to Jikei M., Kakimoto M., Hyperbranched polymers: a promising new class of materials, Prog. Polym. Sci., 26 (2001) 1233-1285, hereby introduced as references and considered part of the disclosure content of the present invention. The highly branched polymers described in this publication are also highly branched polymers which are preferred in the context of the present invention.

Hyperbranched polymers are preferably used in the process of the invention as highly branched polymers for forming a nanoscale discontinuous phase. In this context it is preferred for the hyperbranched polymers to have at least 3 repeating units per molecule, preferably at least 10 repeating units per molecule, more preferably at least 100 repeating units per molecule, with further preference at least 200 repeating units, and more preferably still at least 400 repeating units, each having at least 3, preferably at least 4, binding possibilities, and at least 3 of these repeating units, more preferably at least 10, and more preferably still at least 20 being linked each via at least 3, preferably via at least 4, binding possibilities to at least 3, preferably at least 4, further repeating units. The hyperbranched polymers variously have not more than 10 000, preferably not more than 5000, and more preferably not more than 2500 repeating units.

The term “repeating unit” here refers preferably to a continually recurring structure within the hyperbranched molecule. The term “bonding possibility” refers preferably to the functional structure within a repeating unit that allows linkage to another repeating unit. With reference to the above-depicted examples of a dendrimer or hyperbranched polymer, the repeating unit is a structure having, respectively, three bonding possibilities (X, Y, Z):

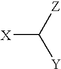

The linking of the individual bonding units to one another can be accomplished by condensation polymerization, free-radical polymerization, anionic polymerization, cationic polymerization, group-transfer polymerization, coordinative polymerization or ring-opening polymerization.

Particularly preferred hyperbranched polymers are polymers in which the bonding units have two bonding possibilities. Hyperbranched polymers preferred in this context are polyethers, polyesters, polyesteramides, and polyethyleneimines. Particularly preferred among these polymers are the hyperbranched polyesters already available commercially under the brand name Boltorn® from Perstorp AB, the hyperbranched polyethyleneimines available as Polyimin® from BASF AG, and the hyperbranched polyesteramides obtainable under the brand name Hybrane® from DSM BV, Netherlands. Another example of a hyperbranched polymer is a polyglycerol polymer with the type designation PG-2, PG-5, and PG-8 from Hyperpolymers GmbH. Mention may be made additionally of polyethyleneimines with the type designation PEI-5 and also PEI-25 from Hyperpolymers GmbH.

It is additionally preferred if the hyperbranched polymers used as added substances in the process of the invention have not only the melting points and vapor pressures specified at the outset but also at least one and preferably all of the following properties:
(α1) (oil) a ratio M_{w}/Mₙ, as determined by combination of analysis methods, in particular by combination of vapor-pressure osmometry and membrane osmometry, alternatively, if desired, by gel permeation chromatography (GPC or SEC) or matrix assisted laser desorption ionization time of flight (MAIDI-TOF) mass spectroscopy, in a range from 1 to 20, more preferably in a range from 1.05 to 10, and more preferably still in a range from 1.1 to 5, M_{w} being the mass average of the molar mass and Mₙ the number average of the molar mass;
(α2) a mass-average molar mass M_{w} in a range from 100 to 500 000 g/mol, more preferably in a range from 400 to 100 000 g/mol, and more preferably still in a range from 1000 to 50 000 g/mol;
(α3) a glass transition temperature T_{g} as determined by means of differential scanning calorimetry (DSC), of greater than −30° C., more preferably greater than 0° C., and more preferably still greater than 10° C.;
(α4) the hyperbranched polymer or mixture thereof is stable up to a temperature of 100° C., more preferably up to a temperature of 150° C., more preferably still up to a temperature of up to 200° C., and with further preference up to a temperature of 300° C., stability here being understood to mean that up to the respective temperature no decomposition of the polymer, through formation of gaseous elimination products, especially carbon dioxide or water, for example, is detectable by gas chromatography down to a limit of below 10 ppm, preferably below 1 ppm, and more preferably 0.1 ppm.

Preferred embodiments of the hyperbranched polymers come about from the individual properties and from combinations of at least two of these properties. Particularly preferred hyperbranched polymers are polymers characterized by the following properties or combinations of properties: α1, α2, α3, α4, α1α2, α1α3, α1α4, α2α3, α2α4, α3α4, α1α2α3, α1α2α4, α1α3α4, α2α3α4, α1α2α3α4.

Particular suitability is possessed by those hyperbranched polymers which have a molar mass of between 400 g/mol and 100 000 g/mol and are obtained by polycondensation, addition reactions or ring-opening reactions—as described by [Jikei, M., Kakimoto, M. in: Progress in Polymer Science, 2001, 26, 1233; Sunder, A., Heinemann, J., Frey, H. in: Chemistry a European Journal, 2000, 6, 2499; Voit, B. in: Journal of Polymer Science, Part A: Polymer Chemistry 2000, 38, 2505]—of ABm monomers with mutually complementary A and B functions, giving a highly branched polymer structure which contains a maximum of one ring (an intramolecular cross-link) per molecule [Sunder, A., Heinemann, J., Frey, H. in: Chemistry a European Journal, 2000, 6, 2499; Voit, B. in: Journal of Polymer Science, Part A: Polymer Chemistry 2000, 38, 2505; Jikei, M., Kakimoto, M. in: Progress in Polymer Science, 2001, 26, 1233].

In the polymerization of ABm monomers it is possible to add up to 95% of linear or cyclic AB monomers, and also polyfunctional molecules with a Bf structure, without losing the fundamental hyperbranched structure [Sunder, A., Heinemann, J., Frey, H. in: Chemistry a European Journal, 2000, 6, 2499; Voit, B. in: Journal of Polymer Science, Part A: Polymer Chemistry 2000, 38, 2505; Kim, Y. H. in: Journal of Polymer Science, Part A: Polymer Chemistry, 1998, 36, 1685; Hult, A., Johansson, M., Malmström, E. in: Advances in Polymer Science, 1999, 143, and also Sunder, A., Hansehnann, R., Frey, H., Mulhaupt, R. in: Macromolecules 1999, 32, 4240; Jikei, M., Kakimoto, M. in: Progress in Polymer Science, 2001, 26, 1233]. In addition to condensable ABm monomers it is also possible to use latent AB* monomers to synthesize hyperbranched polymers, with which the second B group is not activated for branching until during the polymerization. This is the case with self-condensing vinyl polymerization (SCVP) and with self-condensing ring-opening polymerization (SCROP).

To implement the process it is necessary to select a polymer matrix—consisting of one or more base polymers—in accordance with the specific application. Any meltable polymer is suitable in principle.

Examples of suitable base polymers for packaging or containers include polyethylene terephthalate, polypropylene, polyethylene, polystyrene, polyvinyl chloride, polyamide, and polyvinyl alcohol, whereas suitability for paints or coatings is possessed by, in particular, nitrocellulose, chlorinated natural rubber, polyisocyanates, polyureas, polyurethanes, aliphatic, aromatic and/or cycloaliphatic, saturated and/or unsaturated polyesters and/or functionalized polyesters, polyvinyl copolymers, polyvinyl acetate, polyacrylic or polymethacrylic esters, crosslinkable acrylic resin systems, isoboryl acylate systems, epoxy resins, ketone-aldehyde resins, polyesters of terephthalic and isophthalic acid, polyurethanes, polyadducts of bisphenol A and epichlorohydrin, isophuronediamine-based systems, and also polymer systems composed of polyester and/or polyols. Formulations for radiation-curing coatings are known and are described for example in “UV & EB curing formulation for printing inks, coatings & paints” (R. Hohman, P. Oldring, London 1988) and “The Formulation of UV-Curable Powder Coatings” (J. Bender, K. Lehmann et al., RadTech Europe 1999, Conference Proceedings, page 615 f).

The polymers preferably have a molar mass of at least 30 000 g/mol.

As a function of the polymer matrix, then, a suitable dendritic, preferably hyperbranched polymer is to be selected that dissolves homogeneously in the polymer matrix.

To dissolve the dendritic polymer in the polymer matrix the polymer mixture is treated with stirring in a stirred vessel, starting from room temperature, until the polymer mixture is transparent.

In principle it is possible to find a suitable dendritic polymer for any polymer matrix by observing the principle that “like dissolves like”. Depending on the nature of the polymer matrix (polar/nonpolar), a polymer is selected, from among the great diversity of commercially available dendritic macromolecules, whose functional groups enter into attractive interactions with the polymer matrix.

To obtain effective solubility of the dendritic polymer in the polymer matrix, the differences in polarity between matrix and dendritic polymer ought to be small, the intermolecular attractive interactions ought to predominate over the repulsive interactions, and the extent of the intramolecular polymer interactions ought to be small.

The extent of intermolecular and intramolecular interactions can be determined by means of spectroscopic methods such as infrared (IR) spectroscopy (Ullmann's Encyclopedia of Industrial Chemistry (1994), vol. B5, pp. 429-559). Intermolecular forces which occur here include ionic forces, dipol-dipol forces, inductive forces, dispersion forces, and hydrogen bonds (Ullmann's Encyclopedia of Industrial Chemistry (1993), vol. A24, pp. 438-9). Adjusting these forces is resolved in the case of the dendritic polymers by varying the number and type of functional groups. The number of functional groups in a dendritic polymer can be determined by means of nuclear magnetic resonance (NMR) spectroscopy, while the molar mass of a dendritic polymer can be determined by combination of analytical methods, in particular by combination of vapor-pressure osmometry and membrane osmometry, or alternatively, if desired, by gel permeation chromatography (GPC or SEC) or matrix assisted laser desorption ionization time of flight (MALDI-TOF) mass spectroscopy (Ulmann's Encyclopedia of Industrial Chemistry (1994), vol. B5, pp. 155-79 and 429-559).

For a polar polymer matrix, composed for example of a polyester, it is preferred to use a polar dendritic polymer, having, for example, OH groups as functional groups (for example, a hyperbranched Boltorn® polyester from Perstorp or a hyperbranched polyether from Hyperpolymers). In the case of the dendritic polymers it is possible with preference to use low molecular mass specimens in the molar mass range between 400 and 100 000 g/mol, more preferably between 1000 and 50 000 g/mol. The glass transition temperature of the dendritic polymer ought to be greater than 10° C. The glass transition temperature of dendritic polymers rises with increasing endgroup polarity.

With regard to the subsequent procedure a distinction must be made between polymer systems with an upper critical solution temperature (UCST) and systems with a lower critical solution temperature (LCST). Where a polymer melt or polymer solution is situated within the liquid-liquid miscibility gap, the system is turbid. In the case of miscibility gaps with UCST, the turbidity of the polymer system disappears if the temperature is increased sufficiently, whereas with systems with LCST the turbidity disappears as a result of a reduction in temperature. In principle the only polymer mixtures suitable for the process of the invention are those which have

a) an LCST>0° C. or

b) a UCST<250° C. or

c) a closed miscibility gap as described in Chem. Eng. Technol., 25 (2002) 237-53.

In the homogeneously liquid system (composed of a polymer matrix and a dendritic polymer), then, the solubility of the dendritic polymer in the system as a whole is continuously reduced, by controlled, slow temperature change, until initial nuclei of a second, liquid phase—composed of the dendritic polymer—form when the binodal or turbidity curve is exceeded (the upper or lower solution temperature, UST or LST, as described in Macromolecules, 36 (2003) 2085-92). The temperature change to be effected represents, in the case of systems with LCST, a temperature increase at a heating rate of <10 K per minute and, in the case of systems with UCST, a temperature reduction at a cooling rate of <10K per minute.

Since these nanoscale nuclei are formed in situ they are extremely “small” (a few nm) at system temperatures slightly below the upper solution temperature or slightly above the lower solution temperature, and their distribution within the system is extremely uniform. With progressive penetration into the LCST or UCST miscibility gap by means of temperature change, the number of dendritic nuclei formed increases, as does their size. The discontinuous phase can be virtually tailored in respect of droplet size and droplet number/density.

The appropriate temperature range for the formation of the desired nuclei for LCST systems is preferably T_{LCST}<T<(T_{LCST}+50 K), more preferably T_{LCST}<T<(T_{LCST}+20 K), and for UCST systems is preferably T_{UCST}>T>(T_{UCST}−50 K), more preferably T_{UCST}>T>(T_{UCST}−20 K).

The average droplet size in the disperse phase—as determined experimentally, for example, by means of light-scattering experiments (as described by J. Mewis et al. in Chemical Engineering Science, volume 53, issue 12, pages 2231-9), ought not to be greater than 1 μm.

Starting from the final nucleation temperature, this state of an extremely homogeneously distributed, nanoscale disperse phase which is particularly suitable for the permeation properties and mechanical properties of the product, is converted into the solid aggregate state, and hence fixed or “frozen in”, by means of polymerization, intermolecular and/or intramolecular crosslinking, heat treatment, UV curing, pressure reduction and/or evaporation of volatile components of the system.

In one embodiment the process is characterized in that the homogeneity of distribution and agglomerate size of the disperse phase in the polymer mixture are set by temperature changes and the overall system constitutes, for at least one temperature between 20 and 200° C., a dispersion of two liquid phases or one solid phase and at least one liquid phase.

In another embodiment the process is characterized in that solid nanoparticles are coated with one or more dendritic polymers by precipitation, spray drying, spray granulation, operations with compressed gases such as GAS, RESS, PGSS and PCA, are dispersed in the polymer matrix by stirring in the temperature range between 10° C. and 200° C., preferably between 20° C. and 150° C., and dendritic polymers are contained in the polymer mixture with a total concentration of not more than 20 percent by mass.

The dendritic polymer is preferably a hyperbranched aliphatic polyester, hyperbranched aromatic-aliphatic polyester, hyperbranched polyamide, hyperbranched polycarbonate, hyperbranched polyetheresternmide, hyperbranched polyetherester, hyperbranched polyesteramide, hyperbranched polyether, hyperbranched polyethersiloxane, hyperbranched polyethyleneimine, hyperbranched polyurethane, hyperbranched polyurea, hyperbranched polyisocyanate or hyperbranched polyamidoamine and can be dissolved homogeneously in the polymer matrix at 150° C. to an extent of at least 3 percent by mass.

It is also possible for the dendritic polymers additionally to contain functional groups, such as OH, NH₂, NCO and/or COOH groups.

On account of the high compatibility of dendritic polymers with other components, and also of the reduced viscosity of the polymer mixture to be processed—reduced as a result of the branched dendritic molecular structure—it is possible, in one alternative version of the process of the invention, to add, optionally, additives to the system prior to its conversion into the crystalline, semicrystalline or amorphous solid aggregate state, the purpose of said additives being to allow fine-tuning of the profile of properties of the nanocomposite material. On account of the amphiphilic molecular structure of many dendritic polymers, suitable additives, after a cautious stirring phase, surprisingly accumulate around the nanoscale agglomerates, thereby giving the dendritic polymers an additional compatibility-promoting and prodispersing function.

Additives which can be used with particular advantage in the processes of the invention include the following compounds:
modified acrylates such as acrylate-functional organopolysiloxanes, epoxy acrylates, urethane acrylates or polyether acrylates,
inorganic pigments of titanium oxide, iron oxide, chromium oxide, chromate or organic pigments such as carbon black, anthraquinone pigments, azo pigments, flavanthrone pigments, and phthalocyanine pigments,
photoinitiators,
silicone oils or organically modified siloxanes, and
silicone adjuvants.

The compounds can be used as additives in the nanocomposite coatings of the invention, which may also be radiation-curable. They do not have the disadvantages of the prior-art additives, and in radiation-curable coatings they produce a considerable improvement in scratch resistance and lubricity and also in the release behavior. They can be compounded conventionally with curing initiators, fillers, pigments, other known acrylate systems, and further, customary adjuvants. The compounds can be crosslinked three-dimensionally by means of free radicals and cure thermally with the addition, for example, of peroxides or under the influence of high-energy radiation, such as UV radiation or electron beams, within a very short time, to form mechanically and chemically resistant coats which, given an appropriate composition of the compounds, have predeterminable adhesive properties. Where UV light is the radiation source used, crosslinking takes place preferably in the presence of photoinitiators and/or photosensitizers, such as benzophenone and its derivatives, or benzoin and corresponding substituted benzoin derivatives, for example.

Photoinitiators and/or photosensitizers are used in the organopolysiloxane-containing compositions preferably in amounts of 0.01% to 10% by mass, in particular of 0.1% to 5% by mass, based in each case on the weight of the acrylate-functional organopolysiloxanes.

The invention also provides polymer mixtures produced by the process of the invention. The invention therefore provides polymer mixtures obtained by forming nanoscale agglomerates from dendritic polymers having a molar mass of between 400 and 100 000 g/mol by lowering the temperature to below the upper critical solution temperature or raising the temperature to above the lower critical solution temperature of the system in a polymer matrix, and converting the system into the solid aggregate state by polymerization, temperature change, UV curing, pressure lowering, heat treatment or evaporation of volatile components of the system.

On the basis of the low (in comparison to linear polymers) melt viscosity and solution viscosity, and also of the compatibility-promoting and prodispersing properties of dendritic polymers, it has been found, surprisingly, that the polymer mixtures produced in accordance with the invention require less solvent, for coatings, packaging or containers, than in the majority of prior-art processes.

The invention also provides for the use of the polymer mixture produced in accordance with the invention for coatings, packaging, and containers.

The polymer mixtures produced by the process of the invention are particularly suitable for coatings having an improved barrier action with respect to gas permeation and liquid permeation, improved mechanical properties, improved scratch resistance, abrasion resistance, chemical resistance or improved easy-to-clean properties. It is possible to employ the techniques described in the prior art for producing film or applying film (coating methods). Preferred coating methods are knife-coating and dipping methods, spray coating, spin coating, roller methods or casting methods.

Examples below are intended to illustrate the invention; they do not, however, constitute any restriction whatsoever.

### EXAMPLE 1

### Use of a Hyperbranched Additive in Various UV-Curing Coating Systems

Preparation of a Hyperbranched, Polyester-Modified Polyethyleneimine

Compound 1:

44 g of hyperbranched polyethyleneimine (Lupasol PR 8515, BASF AG) and 1152 g of epsilon-caprolactone were charged to a round-bottomed flask and 1.2 g of tin dioctoate were added.

The mixture was stirred at 160° C. for 6 hours.

This gave a crystalline product having a melting range of between 42 to 47° C. The solids fraction of the reaction product after heating (1 hour at 120° C.) was 99.2% by mass.

The performance properties of a variety of compounds for use in accordance with the invention are shown below.

As compounds for use in accordance with the invention, the compounds 1 were tested. To investigate the performance properties, the following printing ink formulas are selected (amounts in % by mass):

Formula 1:

| | |
|---|---|
| Ebecryl ® 605 | 44.7 parts aromatic polyether acrylate, UCB |
| Lauromer ® TPGDA | 45.3 parts tripropylene glycol diacrylate, BASF |
| Benzophenone | 5.0 parts benzophenone, Merck |
| Ebecryl ® P115 | 5.0 parts amine-functional acrylate, UCB |

Formula 2:

| | |
|---|---|
| Laromer ® PO84 F | 95.0 parts polyether acrylate, BASF |
| Darocure ® 1173 | 3.0 parts photoinitiator, Merck |
| Ebecryl ® P 115 | 2.0 parts amine-functional acrylate, UCB |

The printing inks are formulated conventionally in accordance with the formulas above, at 60° C. The last ingredient added in each case is the compound 1, at a rate of between 3% and 10% by mass, based on the printing ink, incorporation taking place by means of a beadmill disk at 2500 rpm for one minute. Prior to application, the additized printing ink is cooled to 25° C. at a rate of 1 K/min, maintaining the temperature ranges according to the invention, and stored at this temperature for 24 hours.

The printing inks are knife-coated at 12 μm wet onto corona-pretreated PVC film at 25° C. Curing takes place by exposure to ultraviolet light (UV curing) at 120 W/cm with web speeds of 20 m/min. This operation is repeated once in each case.

The release values are determined using an adhesive tape from Beiersdorf which is 25 mm wide, has a coating of rubber adhesive, and is available commercially under the name Tesa®4154. To measure the abhesiveness, this adhesive tape is rolled on at 70 g/cm² 5 minutes and, respectively, 24 hours after the curing of the printing ink. After storage of the system at room temperature for three hours, a measurement is made of the force required to peel the respective adhesive tape from the substrate at a speed of 12 mm/s and a peel angle of 180°. This force is termed the release value.

Scratch resistance is the resistance of a surface to visible damage in the form of lines, caused by hard moving bodies in contact with the surface. So-called scratch values are measured using a specially converted electrically driven film applicator. The inserted doctor blade is replaced on the moving blade mount by a plate which lies on rollers at the other end of the applicator. By means of the blade mount it is possible to move the plate, to which the substrate (film coated with printing ink) is fixed. In order to simulate scratching stress, a block with three points is placed on the printing ink film and weighted with 500 g. The test film on the plate is pulled away beneath the weight at a speed of 12 mm/s. The vertical force required to do this is measured and designated as the scratch value. The scratch values are each determined 24 hours after the inks have cured.

If the pointed block is replaced by a block with a flat felt underlay, and the procedure described above is repeated, then the frictional force measured is the friction coefficient. These tests also each take place 24 hours after the inks have cured.

Tables 1 and 2 show average values for 5 individual measurements.

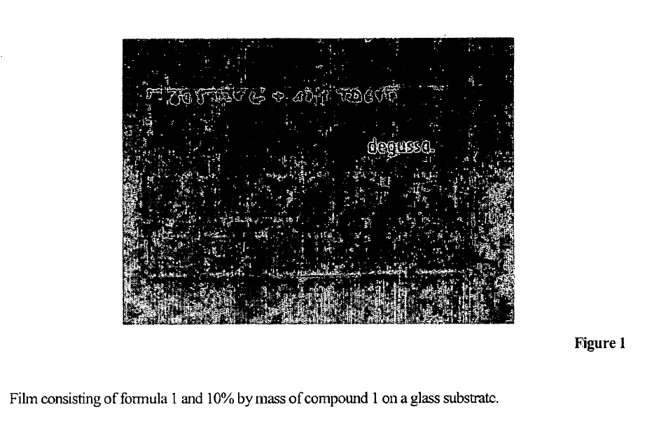

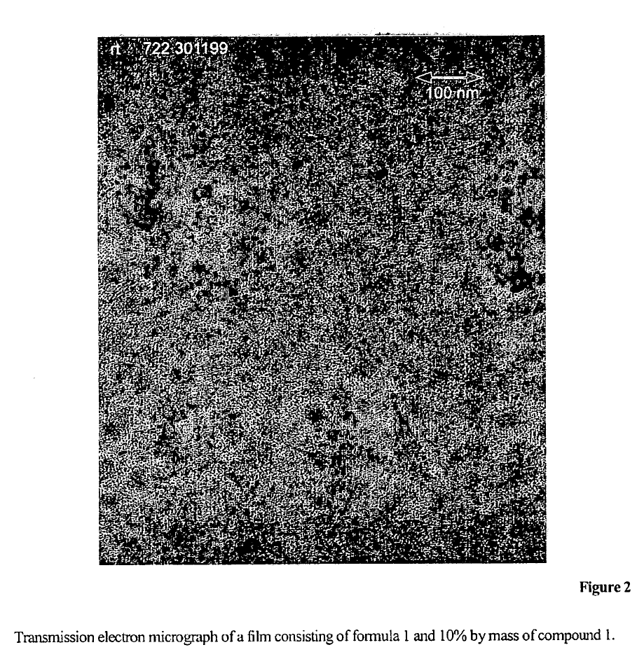

The transparency of the coating material is ensured in all of the samples investigated, despite the nanoscale discontinuous phase apparent from FIG. 2 and composed of hyperbranched polymers. FIG. 1 shows a clear and transparent cured film consisting of formula 1 and 10% by mass of compound 1 on a glass substrate.

FIG. 2 is a transmission electron micrograph of the film shown in FIG. 1. Distinct phase separation is apparent. For transmission electron micrograph purposes, thin sections were produced in a microtome (Ultracut E, Reichert-Jung). The thickness of the sections was approximately 40 nm. The micrographs were taken using a Zeiss microscope (CEM 902) with an acceleration voltage of 80 kV, and also with a LEO 912 at 120 kV.

TABLE 1
(Formula 1)

| | | Friction | Release | |
|---|---|---|---|---|
| | Conc. in % | coefficient | force | Transparency |
| Compound | by mass | [cN] | [cN] | of coating |
| Blind | 0 | 412 | 1024 | clear and transparent |
| 1 | 3 | 128 | 910 | clear and transparent |
| 1 | 5 | 251 | 757 | clear and transparent |
| 1 | 10 | 255 | 746 | clear and transparent |

TABLE 2
(Formula 2)

| | | Friction | | |
|---|---|---|---|---|
| | Conc. in % | coefficient | Release | Transparency |
| Compound | by mass | [cN] | force [cN] | of coating |
| Blind | 0 | 449 | 1040 | clear and transparent |
| 1 | 3 | 290 | 886 | clear and transparent |
| 1 | 5 | 279 | 800 | clear and transparent |
| 1 | 10 | 322 | 816 | clear and transparent |

Tables 1 and 2 show that by employing the process of the invention and using the hyperbranched additive of the invention, as compared with the comparative specimen without compound 1 (blank value), lower friction coefficients and release forces are obtained in both formulas.

### EXAMPLE 2

Polymer matrix:

polyethylene terephthalate, M_{w}=100 000 g/mol

inventive barrier component:

hyperbranched polyester

M_{w}=10 500 g/mol

polydispersity Mw/Mn=1.7

hydroxyl number=26 mg KOH/g

acid number=8 mg KOH/g

viscosity (80° C., 30 s⁻¹)=250 Pas

melting point=60° C.

The barrier component of the invention was obtained by modifying the commercially available hyperbranched Boltorn® H30 with a mixture of arachidic acid and behenic acid. The degree of functionalization is 90% (based on the hydroxyl groups of Boltorn® H30)

The hydroxyl number is determined in accordance with ASTM E222. In this case the polymer is reacted with a defined amount of acetic anhydride. Unreacted acetic anhydride is hydrolyzed with water. The mixture is then titrated with NaOH. The hydroxyl number is given by the difference between a comparison sample and the value measured for the polymer. In this case it is necessary to take account of the number of acid groups in the polymer.

The hyperbranched polymer has a molecular weight of 10 500 g/mol. This figure refers to the weight average of the molecular weight (Mw), which can be measured by means of gel permeation chromatography, measurement taking place in DMF using polyethylene glycols as the reference (cf., inter alia, Burgath et al. in Macromol.Chem. Phys., 201 (2000) 782-91). In this case a calibration plot is used that was obtained using polystyrene standards. This figure therefore represents an apparent value.

The polydispersity Mw/Mn of preferred hyperbranched polymers is located preferably in the range from 1.01 to 6.0, more preferably in the range from 1.10 to 5.0, and very preferably in the range from 1.2 to 3.0, the number average of the molecular weight (Mn) being likewise obtainable by means of GPC.

The viscosity of the hyperbranched polymer can be measured by means of rotational viscometry at 80° C. and 30 s⁻¹ between two 20 mm plates.

The acid number can be measured by titration with NaOH (cf. DIN 53402).

The melting point can be determined by means of differential scanning calorimetry (DSC), using, for example, the Mettler DSC 27 HP apparatus and a heating rate of 10° C./min.

Compound 2:

polymer matrix/barrier component=90%/10% by mass
layer thickness of compound 2=20 □m
cooling rate: 0.1 K/min
cooling from 180° C. to T=T_{UCST}−10 K

average size of agglomerate in discontinuous phase=40 nm

| | Oxygen permeability | Water vapor permeability at |
|---|---|---|
| | at 25° C. | 25° C. |
| | at 50% relative | at 50% relative |
| | humidity | humidity |
| | [cm³ mm/(m² bar 24 h)] | [cm³ mm/(m² bar 24 h)] |
| Polyethylene | 7 | 3 |
| terephthalate | | |
| Compound 2 | 0.1 | 0.3 |

The oxygen permeability was measured using a modified ASTM (American Society for Testing and Materials) standard method, D3985-81.

The water vapor permeability was determined gravimetrically using the ASTM standard method E-96.

Example 2 shows that the process of the invention leads to reduced oxygen permeability and water vapor permeability for compound 2 in comparison to unadditized polyethylene terephthalate.

### EXAMPLE 3

Example batch 3: A three-necked flask provided with stirrer, internal thermometer, dropping funnel and gas inlet tube is charged with 600.0 g of 1-isocyanato-3-isocyanatomethyl-3,5,5-trimethylcyclohexane (CAS 4098-71-9, IPDI) and 0.12 g of dibutyltin dilaurate (CAS 77-58-7, DBTL) at 23° C. with nitrogen blanketing. 180 g of 1,1,1-trimethylolpropane (CAS 77-99-6, TMP) are dissolved in 800 g of butyl acetate (CAS 123-86-4, BA) with heating at 60° C. and with stirring. The solution of TMP in BA, which is at a temperature of 60° C., is added with continuous stirring to the mixture of IPDI/DBTL, which is at a temperature of 23° C., the addition taking place via a glass funnel. The temperature of the mixture is 50° C. After the end of the addition, the temperature of the reaction mixture rises to 82° C. and is adjusted to 55° C. using a water bath. When an NCO content (determined in accordance with DIN EN ISO 11909) of 6.0% by weight is reached, 133.33 g of dicyclohexylmethane 4,4′-diisocyanate (CAS 5124-30-1, H12MDI) are added and the mixture is heated to 60° C. and stirred at that temperature for 1 h. Thereafter the solution has an NCO content of 5.8% by weight.

In accordance with the same experimental description, batches 1 and 2 (see Table 3 below) are carried out, in different amounts (as indicated).

The product from batch 3 possesses a Hazen color number (determined in accordance with DIN ISO 6271) of 13 and a viscosity (determined in accordance with DIN 53019) of 6460.2 [mPas].

TABLE 3

| | Batch 1 | Batch 2 | Batch 3 | |
|---|---|---|---|---|
| IPDI | 375.0 | 487.5 | 600.0 | g |
| TMP | 112.5 | 146.3 | 180.0 | g |
| BA | 400.0 | 520.0 | 800.0 | g |
| DBTL | 0.075 | 0.1 | 0.12 | g |
| H12MDI | 83.33 | 108.3 | 133.33 | g |
| Total | 970.9 | 1262.2 | 1713.4 | g |

The synthesis product of TMP and IPDI with subsequent treatment with H12MDI prepared in accordance with example batch 3, represents a combination of hyperbranched polyisocyanates with a diisocyanate. In this way it was possible to formulate for example an adduct having an NCO content of 5.8% by weight (described in batch 3). Broad variation is possible by means of this procedure. The H12MDI modified component is catalyzed by DABCO in the curing process, and so gives rise to intermolecular/(preferably) intramolecular crosslinking of the hyperbranched polyisocyanate. This additional crosslinking is reflected, surprisingly, in the improved mechanical properties of the films, to a marked degree. The modified adduct prepared is used in accordance with the process of the invention as follows:

Reference 1 (Prior Art):

25.62 g Vestanat HT 2500LV (CAS 28182-81-2, 99.75%)
87.36 g Macrynal SM 510n/60LG (Cytec Surface Specialties)
43.0 g BA/xylene 1:1
0.7 g DBTL 1% in BA (1% based on the resin)
0.31 g Tego Flow 300 (0.2% based on the whole system) (Degussa AG, Tego Chemie Service GmbH)
6.12 g Dibasic ester DBE (4% based on the whole system) (Sigma Aldrich Chemie GmbH)
   System 1:
P 36.47 g adduct from example batch 3
39.14 g Macrynal SM 510n/60LG
36.0 g BA/xylene in 1:1 ratio
0.42 g DBTL 1% in BA (1% based on the resin)
0.22 g Tego Flow 300 (0.2% based on the whole system)
4.49 g DBE (4% based on the whole system)
0.29 g DABCO (1,4-diazabicyclo[2.2.2]octane, CAS 280-57-9) 5% in BA (0.26% based on the whole system)

Both systems are cured at a temperature of 140° C. for a duration of 30 minutes. The viscosity is adjusted beforehand to 20 [mPas].

Reference 2

10.0 g HT 2500LV
17.05 g Macrynal SM 510n/60LG
29.2 g Oxyester T 1136, bifunctional hydroxyl-containing polyester, Degussa AG, Coatings and Colorants)
18.0 g BA/xylene in 1:1 ratio
0.5 g DBTL 1% in BA (1% based on the resin)
0.15 g Tego Flow 300 (0.2% based on the whole system)
2.97 g DBE (4% based on the whole system)
   System 2:
18.26 g adduct from example batch 3
4.90 g Macrynal SM 510n/60LG
5.34 g Oxyester T1136
18.0 g BA/xylene 1:1
0.18 g DBTL 1% in BA (1% based on the resin)
0.10 g Tego Flow 300 (0.2% based on the whole system)
1.87 g BE (4% based on the whole system)
0.05 g DABCO 5% in BA (0.26% based on the whole system)

Both film systems are cured at a temperature of 140° C. for a duration of 30 minutes. It was found that reference 2 does not cure fully and therefore, owing to the excessively poor film properties, did not allow any mechanical tests at all (film thickness, cross-cut Buchholz impression hardness, pendulum hardness, cupping, ball impact or scratch resistance). The viscosity is adjusted beforehand to 20 [mPas].

Technical Testing (Selected Tests):

TABLE 4

| | Reference 1 | System 1 |
|---|---|---|
| Film thickness [μm], DIN 2178 | 21-22 | 22-26 |
| Cross-cut DIN 2409 | 0B | 0B |
| Impression hardness (Buchholz) | 111 | 125 |
| DIN 2815 | | |
| Pendulum hardness [s] DIN 1522 | 194 | 204 |
| Scratch resistance [N] at a film thickness of | 5 | 8-9 |
| 80 [μm] | | |

TABLE 5

| | System 2 |
|---|---|
| Film thickness [μm], DIN 2178 | 21-27 |
| Cross-cut DIN 2409 | 0B |
| Cupping [mm] DIN 1520 | 10.5 |
| Ball impact [in lb] | >160 |
| ASTM D 2794-93 | |
| Scratch resistance [N] at a film thickness of 80 [μm] | 6-7 |

Table 4 shows that the inventive system 1 scores over the prior art (reference 1) by distinct improved mechanical properties, especially hardness and scratch resistance. This is apparent from the impression hardness measured by the method of Buchholz (DIN 2851), from the pendulum hardness measured in accordance with DIN 1522, and from the test with the hardness testing rod (type 318) from Erichsen. The scratch test with the hardness testing rod (type 318) from Erichsen was carried out using the number 4 engraving point (Opel—0.5 mm diameter, specific point geometry and length) using the 0 to 10 [N] spring from Erichsen.

It is clear from Table 5, moreover, that in relation to reference 2 it was possible to obtain a marked improvement in mechanical properties in the form of adhesion, elasticity, and scratch resistance, surprisingly, with measurement carried out of cupping in accordance with DIN 1520, ball impact in accordance with ASTM D 2794-93, and testing with the hardness testing rod (type 318) from Erichsen.

1: A process for producing a polymer mixture, wherein nanoscale agglomerates of dendritic polymers having a molar mass of between 400 and 100 000 g/mol are formed by lowering the temperature below the upper critical solution temperature or raising the temperature above the lower critical solution temperature of a system in a polymer matrix, and the system is converted into a solid aggregate state by polymerization, temperature change, UV curing, pressure lowering, heat treatment and/or evaporation of volatile components of the system.

2: The process of claim 1, wherein the nanoscale polymer agglomerates are composed of one or more dendritic polymers having a glass transition temperature above 10° C. and have a concentration in the polymer mixture of not more than 50% by mass, preferably not more than 40% by mass.

3: The process of one claim 1 wherein the nanoscale polymer agglomerates have at least one and of the following properties:
(α1) a ratio M_{w}/Mₙ, as determined by combination of analysis methods in a range from 1 to 20, M_{w} being the mass average of the molar mass and Mₙ the number average of the molar mass;
(α2) a mass-average molar mass M_{w} in a range from 100 to 500 000 g/mol;
(α3) a glass transition temperature T_{g}, as determined by means of differential scanning calorimetry (DSC), of greater than −30° C.;
(α4) the hyperbranched polymer or mixture thereof is stable up to a temperature of 300° C., stability here being understood to mean that up to the respective temperature no decomposition of the polymer, through formation of gaseous elimination products, especially carbon dioxide or water, for example, is detectable by gas chromatography down to a limit of below 10 ppm.

4: The process of claim 1, wherein the dendritic polymer is a hyperbranched aliphatic polyester, hyperbranched aromatic-aliphatic polyester, hyperbranched polyamide, hyperbranched polycarbonate, hyperbranched polyetheresteramide, hyperbranched polyetherester, hyperbranched polyesteramide, hyperbranched polyether, hyperbranched polyethersiloxane, hyperbranched polyethyleneimine, hyperbranched polyurethane, hyperbranched polyurea, hyperbranched polyisocyanate or hyperbranched polyamidoamine and can be dissolved homogeneously in the polymer matrix at 150° C. to an extent of at least 3 percent by mass.

5: The process of claim 1 wherein the polymer matrix is composed of at least one polymer selected from the group of polyethylene terephthalate, polypropylene, polyethylene, polystyrene, polyvinyl chloride, polyamide, polyisocyanates, polyurethanes, polyureas, polyvinyl alcohol, polyvinyl acetate, nitrocellulose, polyvinyl resin, aliphatic, aromatic and/or cycloaliphatic, saturated and/or unsaturated polyesters and/or functionalized polyesters, epoxy resins, ketone-aldehyde resins, polyacrylic esters, chlorinated natural rubber, vinyl acetate, maleic anhydride, and acrylic acid.

6: The process of claim 1, wherein the upper critical solution temperature of the polymer mixture is <250° C. or the lower critical solution temperature is >0° C.

7: The process of claim 1, wherein nanoscale polymer agglomerates are formed, in a concentration range of 1% to 50% by mass of dendritic polymers in the polymer mixture, by a temperature lowering of not more than 50 K below the upper solution temperature or a temperature raising of not more than 50 K above the lower solution temperature of the system in a polymer matrix.

8: The process of claim 1 wherein, prior to conversion into a solid aggregate state, additives are mixed into the polymer matrix, said additives being selected from the group consisting of
modified acrylates such as acrylate-functional organopolysiloxanes, epoxy acrylates, urethane acrylates or polyether acrylates,
inorganic pigments of titanium oxide, iron oxide, chromium oxide, chromate or organic pigments such as carbon black, anthraquinone pigments, azo pigments, flavanthrone pigments, and phthalocyanine pigments,
photoinitiators and/or photosensitizers,
silicone oils, and
organically modified siloxanes.

9: The process of claim 1 wherein the homogeneity of distribution and agglomerate size of the disperse phase in the polymer mixture are set by temperature changes and the overall system constitutes, for at least one temperature between 20 and 200° C., a dispersion of two liquid phases or one solid phase and at least one liquid phase.

10: The process of claim 1, wherein solid nanoparticles are coated with one or more dendritic polymers by precipitation, spray drying, spray granulation, operations with compressed gases such as GAS, RESS, PGSS and PCA, are dispersed in the polymer matrix by stirring in the temperature range between 10° C. and 200° C. and dendritic polymers are contained in the polymer mixture with a total concentration of not more than 20 percent by mass.

11: A polymer mixture obtained by forming nanoscale agglomerates from dendritic polymers having a molar mass of between 400 and 100 000 g/mol by lowering the temperature below the upper critical solution temperature of a system in a polymer matrix, and converting the system into the solid aggregate state by polymerization, temperature change, UV curing, pressure lowering, heat treatment or evaporation of volatile components of the system.

12: The polymer mixture of claim 11, produced by a process of claim 2.

13. (canceled)

14: A coating having an improved barrier action with respect to gas permeation and liquid permeation, improved mechanical properties, improved scratch resistance, abrasion resistance, chemical resistance or improved easy-to-clean properties, the coating containing a polymer mixture of claim 1.

15: The coating of claim 14, wherein said coating has been produced by knife-coating and dipping methods, spray coating, spin coating, rolling methods or casting methods.

16: The process of claim 3, wherein the ration M_{w}/Mₙ is determined by combination of a vapor pressure osmometry and a membrane osmometry; if desired, a gel permeation chromatography (GPC or SEC); and, if desired, a matrix assisted laser desorption ionization time of flight (MALDI TOF) mass spectrometry.
